(19) United States
(12) Patent Application Publication
(10) Pub. No.: US 2002/0094838 A1
(43) Pub. Date: Jul. 18, 2002

(54) Structure of film type keyboard of cellular phones

(76) Inventor: Hsiang-Hua Wang, Taipei City (TW)

Correspondence Address: Hsiang-Hua WANG, PO Box 82-144, Taipei, TW

(21) Appl. No.: 09/904,537

(22) Filed: Jul. 16, 2001

(30) Foreign Application Priority Data
Jan. 12, 2001 (TW) 090200571

(51) Int. Cl. H04M 1/00

(52) U.S. Cl. 455/550

(57) ABSTRACT

The invention is directed to a structure of film type keyboard panel used in a cellular phone. The cellular phone panel is glued with a film type keyboard panel. The film panel is imprinted with round protruding pad with respect to the openings of the cellular phone panel and the keyboard pillars, so as to have input control of transporting signal and command by contacting the rubber conductive pressing cap through the round protruding pad of the film type pressing keyboard. The bottom layer has a double side tape, so that the tape can be easily avulsed and being affixed onto the house of the cellular phone panel. The invention with objects improves the integral delicacy and eases the matching property.

### BACKGROUND OF THE INVENTION

(a) Field of the Invention

The present invention is to provide a cellular phone, and more particularly, to a structure of a film type keyboard of cellular phones.

(b) Description of the Prior Art:

Nowadays, as the flourish activity and development in industry and business, and great development in information industry, the function of keyboard for a product is also greatly developed with novel design, such as the cellular phone, that is, mobile phone, which can be personally carried. As shown in FIG. 1, a structure for the keyboard of cellular phones to operate the input information is conventional fabricated by the following fabrication method. Mainly, a rubber plate with the same shape as the keyboard structure is adhered on a surface of a conductive silicon rubber layer. The reason to choose the rubber material formed on the bottom portion is that the rubber material is very flexible and can have best electrical contact quality with the printed circuit board. The rubber material does not damage, for example, the printed circuit, which is formed on plastic material with high hardness. As a result, the lift time is effectively prolonged. Moreover, the upper cover designed with plastic material has higher hardness with durable characteristics and very good touching feeling, so that it can protect the worlds imprinted on the surface and allows the shape to have various designs.

Alternatively, a hard protection layer is formed on the surface of the silicon conductive rubber layer by performing a specific electric plating process. The purpose is similar, so as to cause the imprinted words or graphic objects not to be easily peeled away and have the hardness like the plastic material with durable characteristics, and then have the capability of various designs.

However, even though the foregoing conventional fabrication processes can improve the technology to a higher level, the fabrication process is complicated, which is not only time-consuming, but also costs a lot of money. Since the fabrication costs a lot, it does not satisfy the economic consideration for mass production. Moreover, fabrication of the keyboard itself has to associate with the panel style of the cellular phone and the size of openings. Undoubtedly, the ability for the style design and development has reduced. It cannot achieve the properties of diversity and the protruding touch feeling. Comparably, the thickness of the touch panel is not less than 1.3-1.5 mm. Recently, the DIY manner has been a trend. The consumer can change the house of the cellular phone with the desired keyboards by himself, so as to demonstrate the unique personal style. Usually, it is not difficult to fabricate the keyboard with mold manner. However, the adhesion on the electric plating surface or on the surface after the imprinting treatment has poor quality. The imprinted word or graphic symbol on the conventional keyboard with rubber material sold in the stores is easily peeled after a period of time and cause the second energy consumption.

### SUMMARY OF THE INVENTION

In regarding to the foregoing issues, the inventor has made efforts in studies and development to solve the forgoing issues existing in the conventional structure. The invention combines the technology of film fabrication to form the touch panel of the cellular phone, so that the conventional fabrication process for forming the keyboard of cellular phones is simplified. In addition, the total thickness of the cellular phone is reduced (a thickness of the film type keyboard layer together with the conductive pressing cap is about 0.6 mm). The film type keyboard panel is adhered on the panel of the cellular phone, so as to achieve the same operation with touch feeling. Moreover, it has the advantage that the imprinted words are not easily peeled and the color can be changed with various choices.

A second object of the invention is that the adhered film type keyboard panel can be fabricated according to the panel and aspect of cellular phones, so as to provide the user with an easy way with unique touch felling. The user can strip the revamp the panel of the cellular phone based on personal preference by simple stripping and adhering, so as to improve the unique feature of the cellular phone.

In order to achieve the foregoing objects, the invention of film type keyboard used in cellular phones includes a film type keyboard adhered on a panel of a cellular phone. The film panel is imprinted with a round protruding dot, associating with the openings of the phone panel and the conductive pressing cap. By pressing the round protruding dot on the film keyboard to contact the touch pillar of the conductive pressing cap at the bottom portion with rubber material, the signal or command can be inputted for control.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective dissection view, schematically showing a conventional keyboard structure of cellular phones.

FIG. 2 is a perspective view, schematically showing a keyboard structure of cellular phones, according to a preferred embodiment of the invention.

FIG. 3 is a cross-sectional view, schematically showing the keyboard structure of cellular phones, according to a preferred embodiment of the invention.

FIG. 4 is cross-sectional view, schematically showing the keyboard structure of cellular phones having been assembled, according to a preferred embodiment of the invention.

FIG. 5 is a perspective dissection view, schematically showing a keyboard structure of cellular phones, according to a preferred embodiment of the invention.

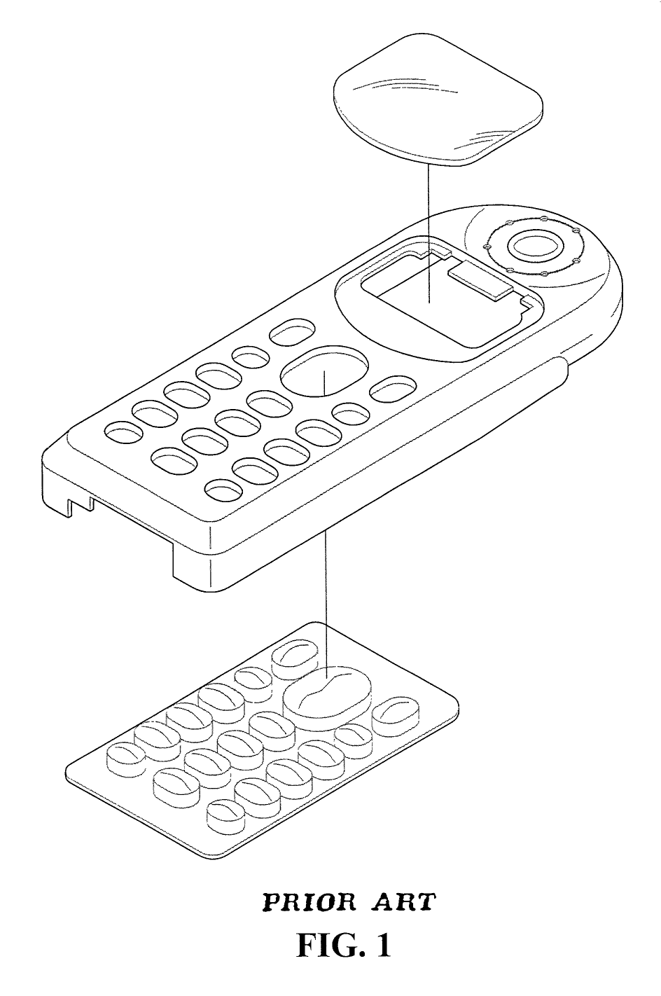

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

According to the function and the structure of the invention, a preferred embodiment is provided in the following with drawings for descriptions, so as to understand the invention in details.

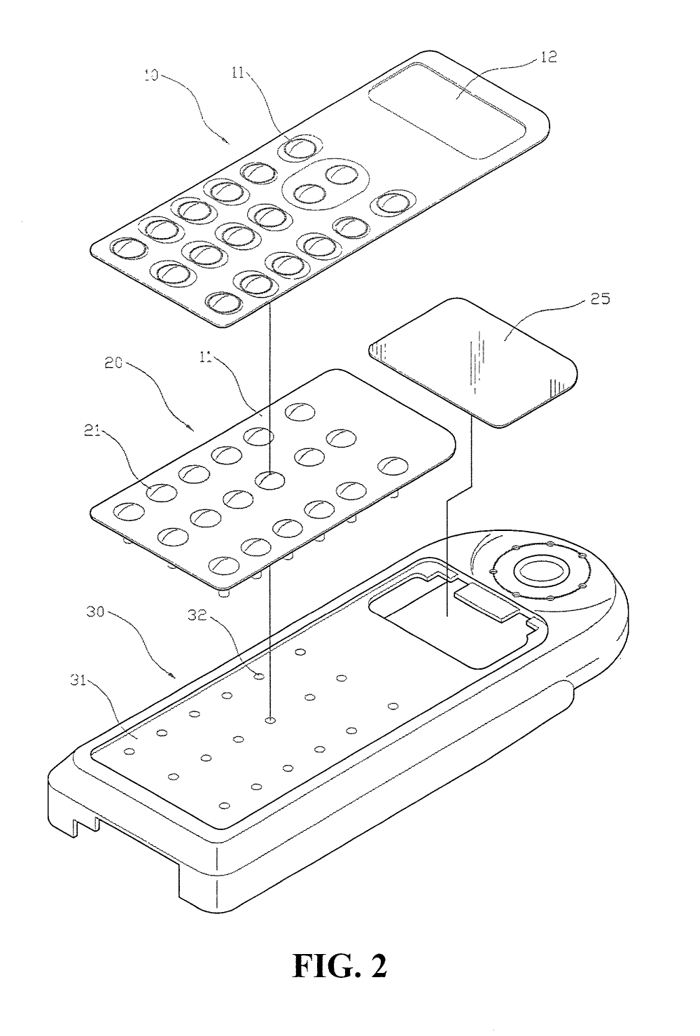

Referring to FIG. 2, the invention of a film type keyboard structure of a cellular phone mainly includes a keyboard panel 10 made of film. Multiple round protruding pads 11 with respect to conductive pressing caps 20 are imprinted on the keyboard panel 10. A view opening 12 is located at top portion of the panel, used for adhering on a transparent panel lens 25, which can include acrylic material. The lower surface has double side tape.

The conductive pressing cap 20 includes rubber material and can have the best conductive contact with the printed circuit board but not damage the printed circuit board, so that it can endure the pressing contact for a long period of operation without damage on the print circuit board. The rubber film 21 has an outer shape takes the same shape as the concave surface 31 of the house panel 30 of the cellular phone. Keyboard contact points 22 are formed on an upper surface of the film 21 corresponding to the round protruding pads 11. Round pillar 23 are also formed on a lower surface of the film 21 under the contact points, wherein a conductive layer is formed over the surface and the rubber film has a slightly concave grooves 24 around the periphery of each of the round protruding pillar; so as to allow the conductive pressing cap to have contact space with property of elastic contact under press. Therefore, it can be put on the keyboard round plug-in holes 32, which is formed on the panel of cellular phones. The design with the protruding round pillar 23 on the conductive pressing cap 20 can simplify the fabrication process for the cellular phone panel 30. According to the actual styles of the film type keyboard panel 10, the round protruding pads 11 have various shapes.

The depositing location of keyboard on the house of the cellular phone panel 30 by itself is fabricated to have a concave surface 31 along the periphery. The keyboards with the desired number are regularly plugged into the plug-in holes 32 with equal spacing on the concave surface, so as to adhere the conductive pressing cap 20 and the film type keyboard panel 32 thereon.

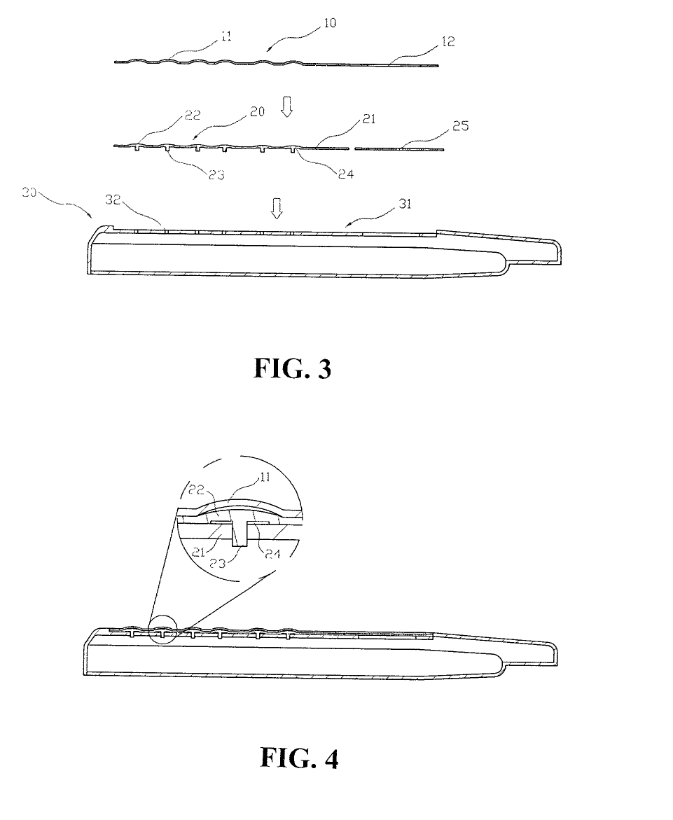

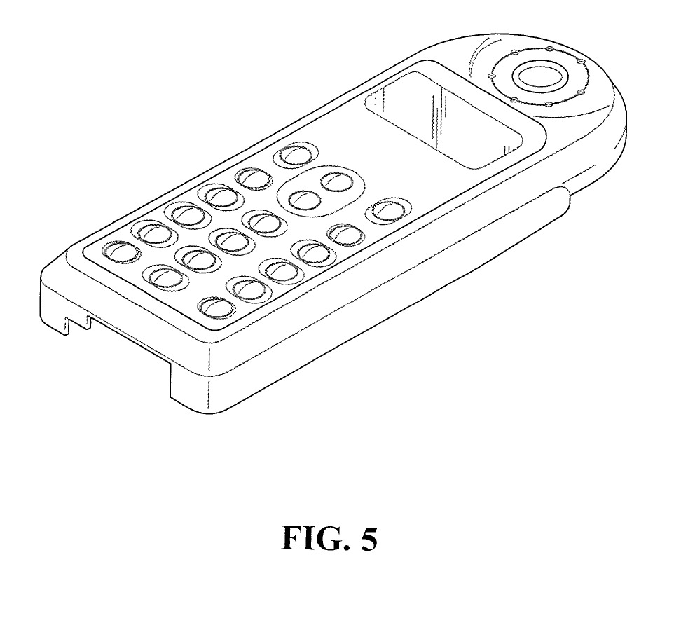

Referring to FIGS. 3 and 4, the round pillar 23 at bottom of the rubber conductive pressing cap 20 is fit into the plug-in holes 32 on the cellular phone panel 30. In the means time, the transparent panel lens 25 is fit into a lens groove of the cellular phone panel 30 and firmly affixed on the panel by gluing it, and then the cover of tape located at bottom of the film type keyboard panel 10 is avulsed away. The adhering tape can be glued on the concave surface 31 of the cellular phone panel and the conductive pressing cap 20. By pressing the protruding round pads 11 on the keyboard panel, it can be pressed to have contact with the conductive pressing cap. The periphery of the conductive pressing cap itself has recessing groove 24, which results in the elastic property of pressing and contact space, so that input control of signal and command between the printed circuit board can be achieved, and it provides a user with simple and unique touch feeling operation.

The arrangement of keyboards, which can associate with the conductive pressing cap in actual design, is imprinted on the film type keyboard panel 10, of which the bottom surface has double side tape, so that the tape can be easily avulsed and glued on the house of the cellular phone panel. The panel style can be changed according to the actual need, so as to achieve the unique property of the selected cellular phone.

In summary, the invention discloses the film type keyboard structure used in cellular phones, so as to change the complicate fabrication process on the convention keyboard touch manner of the cellular phone. The invention fabricates the keyboard panel with the same keyboard function by film and the film type keyboard panel is glued on the cellular phone panel. The total thickness of the keyboard panel of the cellular phone can be effectively reduced, wherein the thickness can be about 0.6 mm. The coating layer of the film type keyboard panel can have preferable choice with variety and is not easily peeled. Under operation, the improved effects have satisfied with novelty in practical use.

I claim:

1. A structure of film type keyboard used in a cellular phone, the structure including a film type keyboard panel, a rubber conductive pressing cap, a lens, and a cellular phone panel, wherein a film of the conductive pressing cap is put on the cellular phone panel, the film type keyboard panel is tightly adhering on a body of the cellular phone panel, the features which include: contacting on the rubber conductive pressing cap layer by slightly pressing a protruding object formed on the film type keyboard panel, whereby an input control for signal and command into a printed circuit board is achieved, so as to provide a user with simple and unique touching feeling operation.

2. The structure of film type keyboard used in a cellular phone according to claim 1, wherein the film type keyboard panel has a plurality of round arc protruding keyboards, whereby the protruding keyboards can be arranged associating with a style of the cellular phone panel.

3. The structure of film type keyboard used in a cellular phone according to claim 2, wherein a front surface of the film type keyboard panel has an opening of view window, used to easily exam information, and be fabricated in an integrated formation.

4. The structure of film type keyboard used in a cellular phone according to claim 1, wherein the film type keyboard panel has a double side tape positioned at a backside, wherein the tape can be easily avulsed, and glued on a house of the cellular phone panel.
